(19) United States
(12) Patent Application Publication
(10) Pub. No.: US 2017/0024121 A1
(43) Pub. Date: Jan. 26, 2017

(54) OPERATING METHOD FOR CONTENTS SEARCHING FUNCTION AND ELECTRONIC DEVICE SUPPORTING THE SAME

(71) Applicant: Samsung Electronics Co., Ltd., Gyeonggi-do (KR)

(72) Inventors: Eun Young PARK, Seoul (KR); Gi Yong Lee, Gyeonggi-do (KR)

(73) Assignee: Samsung Electronics Co., Ltd.

(21) Appl. No.: 15/213,024

(22) Filed: Jul. 18, 2016

(30) Foreign Application Priority Data
Jul. 23, 2015 (KR) 10-2015-0104428

(51) Int. Cl. G06F 3/0488; G11B 27/34; G06F 3/0484

(52) U.S. Cl. CPC G06F 3/04883; G06F 3/04845; G06F 3/04847; G06F 3/04886; G11B 27/34

(57) ABSTRACT

An electronic device and a content locating method are provided. The electronic device includes a memory configured to store a circular gesture user interface (UI) including a circular track object related to control of playback of a video; and a processor connected to the memory, wherein the processor is configured to receive a touch gesture event while the circular gesture UI is displayed on a display, and move and display an indicator along an arc path of the circular track object corresponding to an arc path passing through a plurality of areas in which the touch gesture event occurs.

### PRIORITY

This application claims priority under 35 U.S.C. §119(a) to a Korean Patent Application filed on Jul. 23, 2015 in the Korean Intellectual Property Office and assigned Serial number 10-2015-0104428, the entire disclosure of which is incorporated herein by reference.

### BACKGROUND

1. Field of the Disclosure

The present disclosure relates generally to a content search in an electronic device, and more particularly, to a content search in an electronic device that enables a user to easily locate a certain playback point of content regardless of playback length of the content by providing a circular gesture user interface (UI).

2. Description of the Related Art

Electronic devices support various user functions. For example, electronic devices support a function of playing content (e.g., a video or audio file) including continuous information. Electronic devices may provide a function of starting playback of a video at a certain point in a playback section of the video as needed. In relation to this function, electronic devices provide a linear progress bar corresponding to the total length of a video.

Since a fixed length linear progress bar displayed on a screen corresponds to the total length of a video, the amount of time associated with a section of the video which corresponds to a matching section of the progress bar increases as the duration of the video increases. Therefore, according to the related art, it may be very difficult to locate a certain point in a video by touching a linear progress bar.

### SUMMARY

An aspect of the present disclosure is to provide a content locating function operating method for enabling a user to easily locate a certain playback point of content regardless of a playback length of the content by providing a circular gesture UI and an electronic device supporting the same.

In accordance with an aspect of the present disclosure, an electronic device is provided. The electronic device includes a memory configured to store a circular gesture UI including a circular track object related to control of playback of a video; and a processor connected to the memory, wherein the processor is configured to receive a touch gesture event while the circular gesture UI is displayed on a display, and move and display an indicator along an arc path of the circular track object corresponding to an arc path passing through a plurality of areas in which the touch gesture event occurs.

In accordance with another aspect of the present disclosure, a content locating method is provided. The content locating method includes outputting, by a processor, a circular gesture UI including a circular track object related to playback of continuous information to a display, receiving, by the processor, a touch gesture which occurs over a plurality of areas while the circular gesture UI is displayed, and moving and displaying, by the processor, an indicator along an arc path of the circular track object corresponding to an arc path passing through the plurality of areas.

In accordance with another aspect of the present disclosure, an electronic device is provided. The electronic device includes a touch screen display; a processor electrically connected to the touch screen display; and a memory electrically connected to the processor, wherein the memory is configured to store at least a part of audio/video (A/V) data including a starting point and an endpoint and store instructions that, when executed, cause the processor to: sequentially or continuously play, on the touch screen display, the at least the part of the AV data; display, on the display, a graphical user interface (GUI) representing the starting point, the endpoint, and an indicator, wherein the starting point and the endpoint overlap or are proximate to each other, wherein the indicator is shown on a path formed between the starting point and the endpoint; receive, through the touch screen display, a first gesture input which moves by a first distance or a first angle in a form which is the same as or similar to at least a part of the path; and move the indicator by a second distance selected to be less than the first distance or a second angle selected to be less than the first angle on the path at least partially based on the first gesture input.

### BRIEF DESCRIPTION OF THE DRAWINGS

FIG. 1 is a block diagram of an electronic device operating environment according to an embodiment of the present disclosure;

FIG. 2 is a block diagram of a content operating module according to an embodiment of the present disclosure;

FIG. 3 is a flowchart of a method of locating content according to an embodiment of the present disclosure;

FIG. 4 is a flowchart of a method of operating a circular gesture UI according to an embodiment of the present disclosure;

FIG. 5 is a flowchart of a correction method related to operating a circular gesture UI according to an embodiment of the present disclosure;

FIG. 6 is a flowchart of a method of operating a center point of a circular gesture UI according to an embodiment of the present disclosure;

FIGS. 7A to 7C are diagrams of a screen interface of a circular gesture UI according to an embodiment of the present disclosure;

FIGS. 8A and 8B are diagrams of a screen interface related to correction of a circular gesture UI according to an embodiment of the present disclosure;

FIGS. 9A to 9C are diagrams of a screen interface related to a display of an indicator of a circular gesture UI according to an embodiment of the present disclosure;

FIG. 10 is a block diagram of an electronic device according to an embodiment of the present disclosure; and

FIG. 11 is a block diagram of a program according to an embodiment of the present disclosure.

### DETAILED DESCRIPTION OF EMBODIMENTS OF THE PRESENT DISCLOSURE

Hereinafter, various embodiments of the present disclosure are described in detail with reference to the accompanying drawings. However, it should be understood that the present disclosure is not limited to specific embodiments, but rather includes various modifications, equivalents and/or alternatives of various embodiments of the present disclosure. Regarding the description of the accompanying drawings, like reference numerals may refer to like elements.

The terms “have,” “may have,” “include,” “may include,” “comprise,” and the like used herein indicate the existence of a corresponding feature (e.g., a number, a function, an operation, or an element) but do not exclude the existence of an additional feature.

The terms “A or B,” “at least one of A and/or B,” and “one or more of A and/or B” may each include all possible combinations of items listed together. For example, the terms “A or B,” “at least one of A and B,” and “at least one of A or B” may each indicate all the cases of (1) including at least one A, (2) including at least one B, and (3) including at least one A and at least one B.

The terms “first,” “second,” and the like used herein may each modify various elements regardless of the order and/or priority thereof, but do not limit the elements. For example, “a first user device” and “a second user device” may indicate different user devices regardless of the order or priority. For example, without departing from the spirit and scope of the present disclosure, a first element may be referred to as a second element and vice versa.

When a certain element (e.g., a first element) is referred to as being “operatively or communicatively coupled with/to” or “connected to” another element (e.g., a second element), the certain element may be coupled to the other element directly or via another element (e.g., a third element). However, when a certain element (e.g., a first element) is referred to as being “directly coupled” or “directly connected” to another element (e.g., a second element), there is no intervening element (e.g., a third element) between the elements.

The term “configured (or set) to” used herein may be interchangeably used with the terms, for example, “suitable for,” “having the capacity to,” “designed to,” “adapted to,” “made to,” and “capable of.” The term “configured (or set) to” may not necessarily indicate “specifically designed to.” In some cases, the term “device configured to” may indicate that the device “may perform” together with other devices or components. For example, the term “processor configured (or set) to perform A, B, and C” may indicate a dedicated processor (e.g., an embedded processor) for performing a corresponding operation, or a general purpose processor (e.g., a central processing unit (CPU) or an application processor (AP)) for executing a software program stored in a memory device to perform a corresponding operation.

The terms used herein are only used for describing certain embodiments of the present disclosure and are not intended to limit the scope of the present disclosure. The terms of a singular form may include plural forms unless otherwise specified. The terms used herein have the same meanings as understood by those skilled in the art. Commonly-used terms defined in a dictionary may be interpreted as having meanings that are the same as or similar to contextual meanings defined in the related art, and should not be interpreted in an idealized or overly formal sense unless otherwise defined explicitly. Depending on the case, the terms used herein are not intended to be interpreted to exclude various embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a motion picture experts group (MPEG-1 or MPEG-2) audio layer 3 (MP3) player, a mobile medical device, a camera, or a wearable device (e.g., smartglasses, a head-mounted device (HMD), electronic apparel, an electronic bracelet, an electronic necklace, an electronic appcessory, an electronic tattoo, a smart mirror, or a smartwatch).

Herein, the term “user” used herein may refer to a person who uses an electronic device or may refer to a device (e.g., an electronic device that includes artificial intelligence) that uses an electronic device.

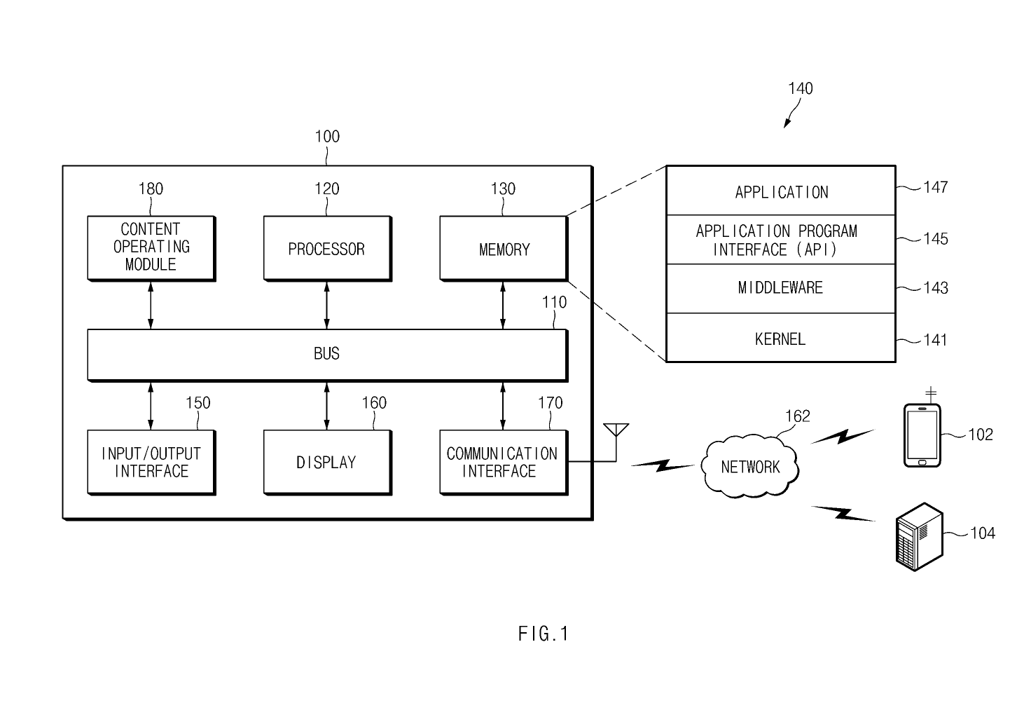

FIG. 1 is a block diagram of an electronic device operating environment according to an embodiment of the present disclosure.

Referring to FIG. 1, the electronic device operating environment may include, for example, an electronic device 100, a network 162, a server 104, and an external electronic device 102.

In the electronic device operating environment, the electronic device 100 may play at least one of content received from the server 104 or the external electronic device 102 or content stored in a memory according to a user input or a setting. In this operation, the electronic device 100 may output a circular gesture UI related to content locating according to the user input or the setting. The circular gesture UI, for example, may include a user interface for providing a path (e.g., a looped curve) of which a starting point and an endpoint are not determined and outputting playback information according to a result of locating in response to reception of a touch gesture input. For example, the circular gesture UI may include a circular track object (or an object having a circular band shape), and may include at least one other object (e.g., a location time display object or an indicator for indicating a location point) disposed adjacent to the circular track object in relation to content locating. The circular gesture UI may have a shape other than a circular shape, such an elliptic shape or various looped curves (e.g., a rectangular band, a triangular band, an octagonal band, a Mobius band, etc.) of which a starting point and an endpoint are connected to each other.

The electronic device 100 may display an indicator of the circular gesture UI in response to reception of an event of controlling the circular gesture UI. The electronic device 100 may change the displayed indicator in response to reception of an event so that the indicator has a certain shape according to an event form. The display 100 may determine whether a location at which an event has been collected is in a certain area, and may sequentially display the indicator at a plurality of points having a certain interval in response to events occurring in the certain area. In this case, the electronic device 100 may move and display the indicator along a circular direction even if events are not input along a circular direction. If an event of a movement greater than or equal to a certain value is received, the electronic device 100 may output the indicator to a point spaced apart by a certain unit interval (a certain angle or a certain distance) from a previously displayed position. In this case, the electronic device 100 may display the indicator so that the indicator does not bounce or stop with respect to a distance traveled or an angle rotated by as much as a certain value or more within a certain time. For example, the electronic device 100 may prevent a display state in which the indicator is not displayed sequentially but is displayed after skipping multiple points at once or stands still so as not be displayed continuously.

The network 162 may support the establishment of a wired communication channel or a wireless communication channel among the electronic device 100, the external electronic device 102, and the server 104. In addition, in the case where the external electronic device 102 includes a wireless communication interface, the network 162 may support the establishment of a wireless communication channel of the external electronic device 102. The network 162 may include at least one device element capable of supporting a wireless communication function (e.g., various wireless communication standards such as second generation (2G), third generation (3G), fourth generation (4G), long term evolution (LTE), fifth generation (5G), etc.), a wireless access communication function (e.g., a wireless fidelity (Wi-Fi) communication function), etc. The network 162 may include at least one of telecommunications networks, for example, a computer network (e.g., a local area network (LAN) or wide area network (WAN)), the Internet, or a telephone network. The network 162 may include a short-range communication network. In this case, data may be transmitted/received based on a short-range communication channel between the electronic device 100 and the server 104, between the electronic device 100 and the external electronic device 102, or between the server 104 and the external electronic device 102. The network 162 may receive content to be played in the electronic device 100 from the server 104 or the external electronic device 102, and may transfer the content to the electronic device 100.

The server 104 may be connected to the electronic device 100 via the network 162. The server 104 may establish a wireless communication channel in response to a request from the electronic device 100. The server 104, for example, may transfer, to the electronic device 100, at least one piece of content (e.g., video content or audio content) in response to a request from the electronic device 100. Content provided by the server 104 may be stored in the electronic device 100. The server 104 may provide content to the electronic device 100 by streaming. The server 104 may receive a locating-related control event from the electronic device 100. In this case, the server 104 may provide, to the electronic device 100, content of a playback point corresponding to a locating event.

The external electronic device 102 may include elements, at least a portion of which are the same as or similar to those of the electronic device 100. The external electronic device 102 may establish a voice or data communication channel to the electronic device 100. The external electronic device 102 may provide certain content to the electronic device 100. In this operation, the external electronic device 102 may output a circular gesture UI, and may adjust a content playback time point according to a user input. Accordingly, the external electronic device 102 may provide a content-playback-time-point-adjusted screen to the electronic device 100.

The electronic device 100 may output a screen according to content playback to a display 160, or may output, via an audio device, audio data according to content playback. The electronic device 100 may output the circular gesture UI according to a user input or a setting. The electronic device 100 may change an indicator display state of the circular gesture UI in response to an occurrence of an event. Furthermore, the electronic device 100 may provide a function of locating a certain playback point of content in response to an occurrence of an event. The electronic device 100 may include a bus 110, a processor 120, a memory 130, an input/output interface 150, the display 160, a communication interface 170, and a content operating module 180.

The bus 110 may include a circuit for connecting the above-mentioned elements 120 to 180 to each other and transferring communications (e.g., control messages and/or data) among the above-mentioned elements 120 to 180. For example, the bus 110 may connect the communication interface 170 to the content operating module 180. The bus 110 may transfer a screen according to content playback to the display 160. The bus 110 may output, to the display 160, image information related to a circular gesture UI. Upon receiving a user input from the display 160 having a touch function, the bus 110 may transfer the user input to the processor 120 or the content operating module 180.

The processor 120 may include at least one of a CPU, an AP, or a communication processor (CP). The processor 120 may control at least one of the other elements of the electronic device 100 and/or process data or operations related to communication. The processor 120 may output a circular gesture UI according to a user input or a certain schedule. The processor 120 may change a display state of the output circular gesture UI according to a movement amount of a received event. In this case, the processor 120 may include at least a part of the content operating module 180, or at least one processor 120 may constitute at least a part of the content operating module 180.

The memory 130 may include a volatile memory and/or a nonvolatile memory. The memory 130 may store instructions or data related to at least one of the other elements of the electronic device 100. The instructions may be executed by at least one of the processor 120 or the content operating module 180. The instructions may include, for example, instructions for calling a player (e.g., an audio player or a video player) related to playback of content when a request for playing the content is made, instructions for outputting a circular gesture UI according to a setting or a user input (e.g., a first touch event), instructions for changing a display state of the circular gesture UI according to a user input (e.g., a second touch event), or instructions to stop outputting the circular gesture UI in response to an end of an event.

The memory 130 may store software and/or a program 140. The program 140 may include, for example, a kernel 141, middleware 143, an application programming interface (API) 145, and/or an application program (or an application) 147. At least a portion of the kernel 141, the middleware 143, or the API 145 may be referred to as an operating system (OS).

The kernel 141 may control or manage system resources (e.g., the bus 110, the processor 120, the content operating module 180, or the memory 130) used to perform operations or functions of other programs (e.g., the middleware 143, the API 145, or the application 147). Furthermore, the kernel 141 may provide an interface for allowing the middleware 143, the API 145, or the application 147 to access individual elements of the electronic device 100 in order to control or manage the system resources.

The middleware 143 may serve as an intermediary so that the API 145 or the application 147 communicates and exchanges data with the kernel 141. Furthermore, the middleware 143 may process one or more task requests received from the application 147 according to a priority order. For example, the middleware 143 may assign at least one application 147 a priority for using the system resources (e.g., the bus 110, the processor 120, the content operating module 180, the memory 180, or the like) of the electronic device 100. For example, the middleware 143 may process the one or more task requests according to the priority assigned to the at least one application 147, thereby performing scheduling or load balancing with respect to the one or more task requests.

The API 145 may include an interface for allowing the application 147 to control functions provided from the kernel 141 or the middleware 143. The API 145 may include, for example, at least one interface or function (e.g., an instruction) for the purpose of file control, window control, image processing, character control, or the like.

The application 147 may include at least one application. For example, the application 147 may include a music application, an exercise (or healthcare) application, an alarm application, etc. The application 147 may include a content player. The content player, for example, may support a function of outputting a circular gesture UI.

The input/output interface 150 may serve to transfer an instruction or data input from a user or another external device to (an)other element(s) of the electronic device 100. Furthermore, the input/output interface 150 may output instructions or data received from (an)other element(s) of the electronic device 100 to the user or another external device. The input/output interface 150 may include, for example, at least one physical button or touch button or a touchpad or a touch screen. Furthermore, the input/output interface 150 may include a means for input by an electronic pen or the like. Moreover, the input/output interface 150 may include an audio device for processing audio signals. The audio device may output audio data related to execution of an application. This audio data output function may not be performed according to a setting or a user input. The input/output interface 150 may output audio information to be output according to execution of an application. According to an embodiment of the present disclosure, in the case where audio information according to execution of an application is set to be output through at least one external electronic device 102, the input/output interface 150 may not output the audio information. The input/output interface 150, for example, may receive an event related to control of a circular gesture UI.

The display 160 may include, for example, a liquid crystal display (LCD), a light-emitting diode (LED) display, an organic light-emitting diode (OLED) display, a microelectromechanical systems (MEMS) display, or an electronic paper display. The display 160 may present various content (e.g., a text, an image, a video, an icon, a symbol, or the like) to a user. The display 160 may include a touch screen, and may receive a touch, gesture, proximity or hovering input from an electronic pen or a part of a body of a user. The display 160 may output, for example, a certain image content playback screen. The display 160 may output a predetermined screen related to playback of audio content. The display 160 may output a circular gesture UI to a content playback screen. The display 160 may change the display state of a circular gesture UI according to a user input and may output the circular gesture UI. For example, the display 160 may output an indicator to a certain point within a circular object corresponding to a circular gesture UI. The display 160 may change a display position of an indicator according to a user input.

The communication interface 170 may set communications between the electronic device 100 and the external electronic device 102 or the server 104. For example, the communication interface 170 may be connected to the network 162 via wireless communications so as to communicate with the external electronic device 102 or the server 104. The communication interface 170 may receive content from the external device, and may transfer the content to an output device (e.g., the display 160, an audio device, or the like).

Wireless communications may employ at least one of cellular communication protocols such as long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). Furthermore, wireless communications may include, for example, short-range communications. The short-range communications may include at least one of Wi-Fi, Bluetooth, near field communication (NFC), magnetic stripe transmission (MST), global navigation satellite system (GNSS), or the like.

The GNSS may include, for example, at least one of global positioning system (GPS), global navigation satellite system (GLONASS), BeiDou navigation satellite system (hereinafter referred to as “BeiDou”), or Galileo, the European global satellite-based navigation system, depending on a use area or bandwidth. Hereinafter, the term “GPS” and the term “GNSS” may be interchangeably used. A wired communication interface may include at least one of a universal serial bus (USB), a high definition multimedia interface (HDMI), recommended standard 232 (RS-232), plain old telephone service (POTS), or the like.

The content operating module 180 may control the operation and output of a circular gesture UI according to an embodiment of the present disclosure. For example, the content operating module 180 may play content specified by a user input or a certain schedule. The content operating module 180 may output the circular gesture UI while content is played. The content operation module 180 may output a certain object such as an indicator to the circular gesture UI in response to an occurrence of an event in such a manner that the indicator is differently displayed according to a movement amount of the event. In this operation, the content operating module 180 may provide a locating function by outputting a certain content playback point according to the event. The content operating module 180 may include at least one processor 120, or at least a part of the processor 120 may be provided as the content operating module 180.

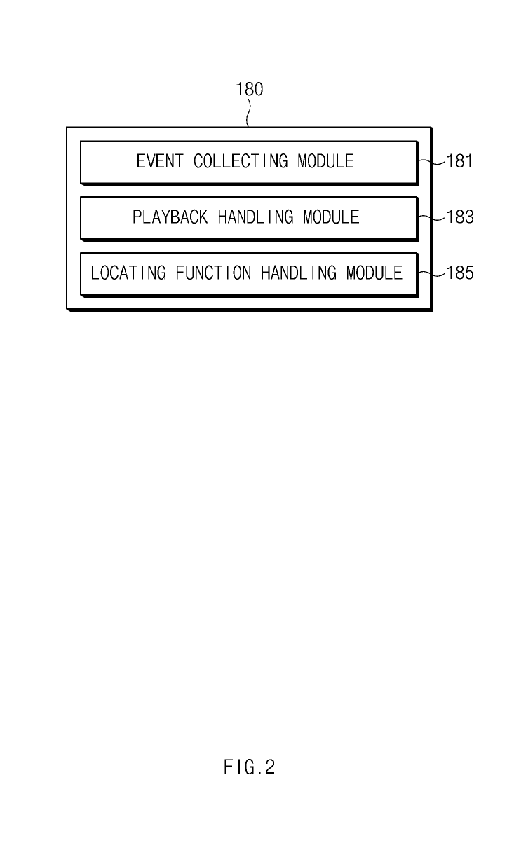

FIG. 2 is a block diagram of a content operating module according to an embodiment of the present disclosure.

Referring to FIG. 2, the content operating module 180 may include an event collecting module 181, a playback handling module 183, and a locating function handling module 185. The event collecting module 181, the playback handling module 183, and the locating function handling module 185 of the content operating module 180 may be provided as individual processors, or may be provided as partial elements of at least one processor. Alternatively, the event collecting module 181, the playback handling module 183, and the locating function handling module 185 may be provided as software modules, and may be stored and operated in a memory area operable by the processor.

The event collecting module 181 may collect an event of the electronic device 100. For example, the event collecting module 181 may collect an event of requesting playback of certain content. When a playback request event is received, the event collecting module 181 may transfer the playback request event to the playback handling module 183. The event collecting module 181 may receive an event of requesting output of a circular gesture UI. For example, the event collecting module 181 may determine a certain content playback requesting event as an event of requesting output of a circular gesture UI (or a looped curve-type gesture UI), and may transfer a collected event to the locating function handling module 185. The event collecting module 181 may receive an event related to a circular gesture UI, and may transfer the event to the locating function handling module 185.

Upon receiving a content playback requesting event, the playback handling module 183 may activate a player required for playing the corresponding event. The playback handling module 183 may play the content as the player is activated, and may output content playback information. The playback handling module 183 may output, to the display 160, a screen according to content playback. Furthermore, the playback handling module 183 may output audio information according to content playback via an audio device. The playback handling module 183 may pause content playback when the circular gesture UI is output. If a certain playback point is selected via a circular gesture UI, the playback handling module 183 may play the content from the selected point, and may output playback information.

The locating function handling module 185 may output the circular gesture UI. If playback of certain content is requested, the locating function handling module 185 may output a circular gesture UI while the playback handling module 183 outputs content playback information. If playback of content is requested, the locating function handling module 185 may output a circular gesture UI for a certain time immediately before the playback. The seeking function handling module 185 may remove a circular gesture UI if an event related to control of the circular gesture UI is not received within a certain time.

If an event related to output of the circular gesture UI occurs while content is played, the locating function handling module 185 may output a circular gesture UI so that the circular gesture UI is overlaid on a playback screen. If a control event related to control of the circular gesture UI is received, the locating function handling module 185 may request the playback handling module 183 to stop playing the content. Accordingly, a content playback stop screen may be output to the display 160.

The locating function handling module 185 may change an output form of a circular gesture UI according to a control event. For example, if a locating control event (e.g., a circular gesture event) is received, the locating function handling module 185 may output an indicator to an area within an object corresponding to the circular gesture UI. The locating function handling module 185 may move and display the indicator according to a direction and a traveled distance of the circular gesture event. The locating function handling module 185 may move the indicator by a certain interval according to the direction and the traveled distance of the circular gesture event while maintaining a displayed state of the indicator. Alternatively, the locating function handling module 185 may move an indicator by a certain interval. The locating function handling module 185 may move the indicator by as much as a certain angle (e.g., 15 degrees) at one time with respect to a center point of the circular gesture UI. When moving the indicator by as much as the certain angle, the locating function handling module 185 may also change a content locating interval into a certain unit of length (e.g., in units of a certain number of frames or in units of a certain playback length). For example, if an event, which corresponds to a point 30 degrees rotated from a previous event occurrence point with respect to a center point of a circular gesture UI, is received, the locating function handling module 185 may sequentially move the indicator, which is displayed at an initial position (e.g., an event occurrence position with respect to the center point of the circular gesture UI) on the circular gesture UI, to a position 15 degrees rotated from the initial position and a position 30 degrees rotated from the initial position. Furthermore, the locating function handling module 185 may output, to the display, a content playback point at which a certain unit elapses two units after the initial point (e.g., a point at which two seconds elapse in the case where the certain unit is a playback length of one second).

The locating function handling module 185 may move the indicator by as much as a certain unit if an event corresponding to a movement change greater than or equal to a certain value occurs within a certain time. For example, the locating function handling module 185 may move an indicator by as much as a certain unit (e.g., 15 degrees) at one time if an event in which an initial position (e.g., an event occurrence position with respect to a center point of a circular gesture UI) on a circular gesture UI rotates 40 degrees with respect to the center point of the circular gesture UI occurs. Accordingly, the locating function handling module 185 may move the indicator output to the initial position on the circular gesture UI to a position 15 degrees rotated from the initial position with respect to the center point of the circular gesture UI, and may output playback information of a playback point obtained by applying a certain unit (e.g., a playback length of one second) to a previous content playback point.

An electronic device may include a touch screen display, a processor electrically connected to the display, and a memory electrically connected to the processor, wherein the memory may be configured to store at least a part of audio/video (A/V) data including a starting point and an endpoint and store instructions that, when executed, cause the processor to sequentially or continuously play, on the display, at least a part of the AV data, display, on the display, a graphical user interface (GUI) representing a starting point, an endpoint, and an indicator, wherein the starting point and the endpoint overlap or are proximate to each other, wherein an indicator is shown on a path formed between the starting point and the endpoint, receive, through the display, a first gesture input which moves by a first distance or a first angle in a form which is the same as or similar to at least a part of the path, and move the indicator by a second distance selected to be less than the first distance or a second angle selected to be less than the first angle on the path at least partially based on the first gesture input.

An electronic device may include a touch screen display, a processor electrically connected to the display, and a memory electrically connected to the processor, wherein the memory may be configured to store at least a part of audio/video (A/V) data including a starting point and an endpoint and store instructions that, when executed, cause the processor to sequentially or continuously play, on the display, at least a part of AV data, display, on a first area of the display, a GUI representing the starting point, an endpoint, and an indicator, wherein the starting point and the endpoint overlap or are proximate to each other, wherein the indicator is shown on a path formed between the starting point and the endpoint, receive a first gesture input through a second area of the display, and move the indicator on the path at least partially based on the first gesture input.

An electronic device may include a touch screen display having a first side and a second side substantially perpendicular to the first side, a processor electrically connected to the display, and a memory electrically connected to the processor, wherein the memory may be configured to store at least a part of A/V data including a starting point and an endpoint and store instructions that, when executed, cause the processor to sequentially or continuously play, on the display, at least the part of the AV data, display, on the display, a GUI representing the starting point, the endpoint, and an indicator, wherein the starting point and the endpoint overlap or are proximate to each other, wherein the indicator is shown on a path formed between the starting point and the endpoint, receive a first gesture input through the display, move the indicator on the path based on a first component of the first gesture input if the first component parallel to the first side is substantially greater than a second component parallel to the second side among components forming the first gesture input, and move the indicator on the path based on the second component if the second component is substantially greater than the first component among the components.

An electronic device may include a memory configured to store a circular gesture UI including a circular track object related to control of playback of continuous information (or playback of a video) and a processor connected to the memory, wherein, if a touch gesture event occurs over a plurality of certain areas while the circular gesture UI is displayed, the processor may move and display an indicator along an arc path of the circular track object corresponding to an arc path passing through the plurality of areas.

A processor may calculate an arbitrary center point by integrating pre-stored touch coordinates and currently received touch coordinates.

A processor may configure a plurality of areas corresponding to a certain angular range of at least one orientation based on a center point.

A processor may configure a plurality of areas corresponding to a certain angular range within north, south, east, and west orientations based on a center point related to an occurrence point of a touch gesture.

A processor may move and display an indicator along a 180-degree arc path in response to a touch gesture which occurs over areas of the north and south (or upper and lower) orientations or the east and west (or left and right) orientations.

A processor may move and display an indicator along a 90-degree arc path in response to a touch gesture which occurs over areas corresponding to an angle of 90 degrees.

A processor may configure a plurality of areas corresponding to a certain angular range in certain directions based on a center point related to an occurrence point of a touch gesture.

A processor may move and display an indicator by as much as a certain angle at one time.

A processor may change a color of at least a part of a circular track object corresponding to an arc path.

A processor may output playback information corresponding to a location point of content being played according to a traveled distance of an indicator.

A processor may output playback information corresponding to a location point of content to which an indicator's traveled distance is applied based on a location length set as a certain unit angle or distance.

If a touch gesture stops moving at an area outside certain areas or the touch gesture, a movement amount of which exceeds a certain value, occurs within a certain time at an area outside the certain areas, a processor may display an indicator at an adjacent area to a circular track object in response to the touch gesture such that the indicator is moved by as much as an angle or a distance corresponding to a certain movement amount value.

An electronic device may include a memory configured to store a circular gesture UI including a circular track object and a processor connected to the memory, wherein the processor may display an indicator at an adjacent area to a circular track object in response to a touch gesture event, a movement amount of which exceeds a certain value and which occurs within a certain time, while the circular gesture UI is displayed, such that the indicator is moved by as much as an angle or a distance corresponding to a certain movement amount value.

A processor may output playback information corresponding to a location point of content to which a location length set as a certain movement amount value is applied.

An electronic device may include a memory configured to store a circular gesture UI including a circular track object and a processor connected to the memory, wherein a processor may calculate a center point based on pre-stored touch coordinates and a touch gesture event which occurs while the circular gesture UI is displayed, and may move and display an indicator on the circular track object according to an angle of movement of a touch gesture with respect to a center point.

A processor may accumulate and store touch coordinates of a touch gesture event with pre-stored touch coordinates.

A processor may store touch coordinates of a touch gesture event, and may delete the oldest touch coordinates from among pre-stored touch coordinates.

A processor may move and display an indicator by handling a touch event which occurs on an area outside a circular gesture UI based on a center point.

A processor may display a location point of content by handling a touch event which occurs on an area outside a circular gesture UI based on a center point.

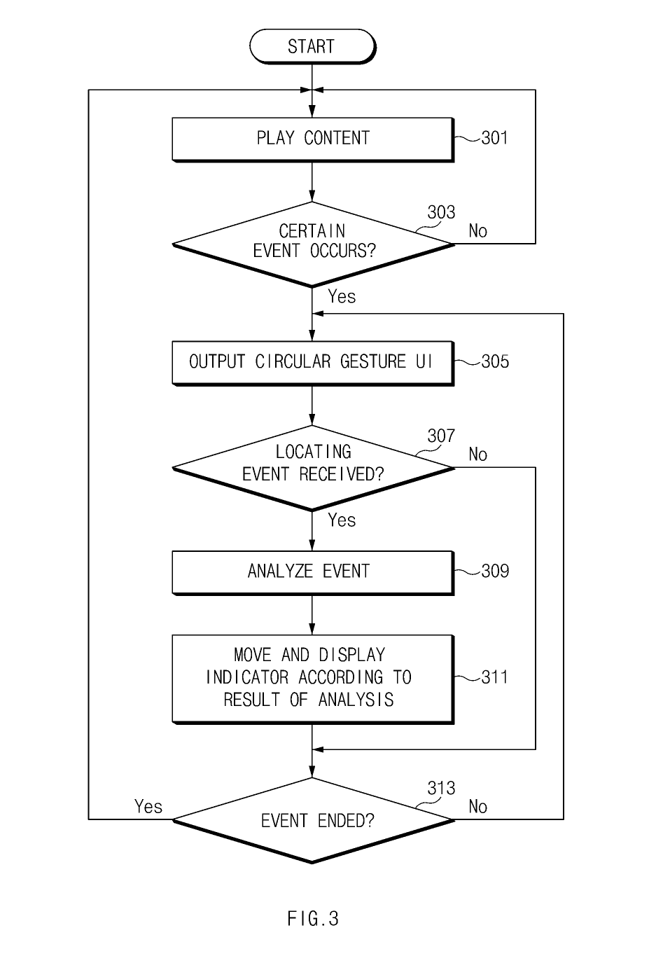

FIG. 3 is a flowchart of a method of locating content according to an embodiment of the present disclosure.

Referring to FIG. 3, the electronic device 100 may play content in operation 301. In relation to this operation, the electronic device 100 may provide an icon or a menu related to content playback. For example, the electronic device 100 may output an icon related to a content playback player or an icon corresponding to a certain video file or music file. If a corresponding icon or menu is selected, the electronic device 100 may play content. The electronic device 100 may play certain content in response to arrival of a certain schedule.

The electronic device 100 may determine whether a certain event occurs in operation 303. If the certain event does not occur, the process may return to operation 301 so that the electronic device 100 may maintain a content playback state. If an event of requesting a stop to content playback occurs, the electronic device 100 may stop playing content. Alternatively, according to the type of an event that occurs, the electronic device 100 may output a certain function execution screen to the display 160 or may transition to a reduced power (e.g. sleep) state.

If a certain event (e.g., an event related to a request for a locating function) occurs, the electronic device 100 may output a circular gesture UI to the display in operation 305. For example, the electronic device 100 may output the circular gesture UI to the display upon receiving an event of touching a certain point on a content playback screen or an event of touching an icon or a menu item output in relation to the circular gesture UI.

The electronic device 100 may determine whether a locating event is received in operation 307. For example, the electronic device 100 may determine whether an event of touching and dragging a circular track object among objects that form the circular gesture UI is received. The electronic device 100 may determine, as the locating event, an event of touching and dragging a certain point on a display area while the circular gesture UI is output to the display 160.

If a locating event is received, the electronic device 100 may analyze the received event in operation 309. For example, the electronic device 100 may calculate an event movement amount (e.g., a value of an angular change due to movement of the event with respect to a center point of a circular gesture UI, or a value of a distance change due to the movement).

The electronic device 100 may move an indicator according to a result of an analysis in operation 311. In operation 311, the electronic device 100 may move an indicator by a certain unit amount at one time according to the event movement amount. In relation to operation 311, the electronic device 100 may determine whether the event movement amount is greater than or equal to a certain unit angle or unit distance. In a case where the event movement amount is greater than or equal to a certain unit angle or unit distance, the electronic device 100 may move the indicator to a position spaced apart by as much as the certain unit angle or unit distance from a previous position of the indicator. When moving the indicator, the electronic device 100 may output a content locating screen. In this operation, the electronic device 100 may output a content locating position moved from a previous playback point by as much as a value set as the certain unit. For example, if a locating position moving length per certain unit is set as a playback length of two seconds, the electronic device 100 may output corresponding content information to a locating position at which a playback length has been changed by two seconds for each certain unit (e.g., an angle of 15 degrees).

The electronic device 100 may determine whether the event has ended in operation 313. If the event has not ended, the process may return to operation 305 so that the electronic device 100 may re-perform operation 305 and the following operations. When the locating event has ended, the process may return to operation 301 so that the electronic device 100 may maintain the content playback state. In 313 operation, the electronic device 100 may remove the circular gesture UI from the display 160.

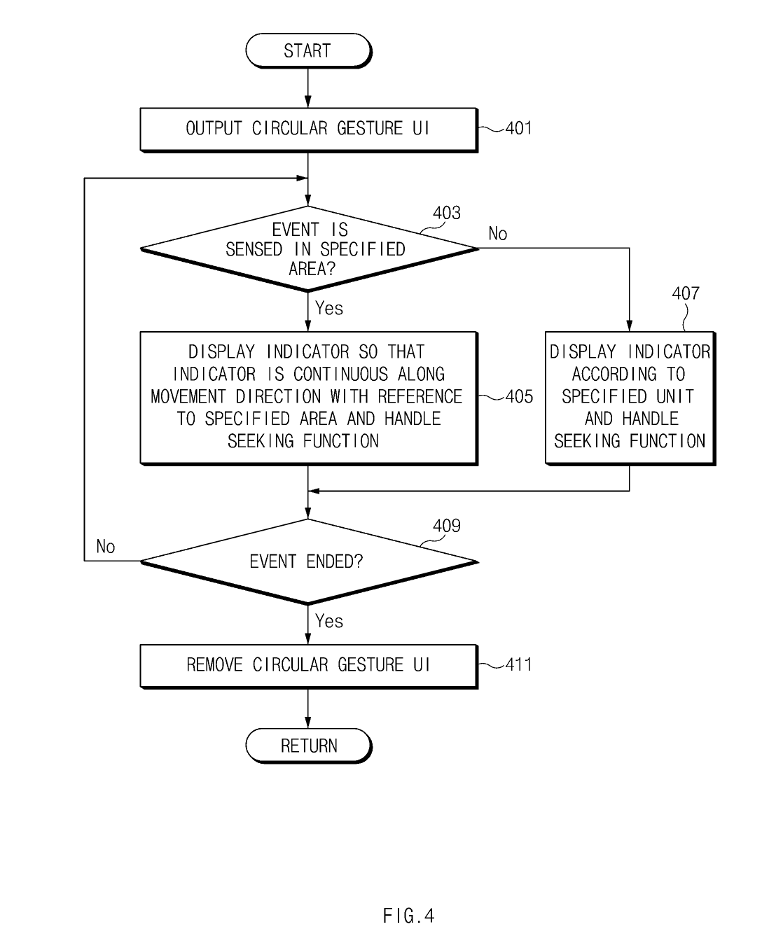

FIG. 4 is a flowchart of a method of operating a circular gesture UI according to an embodiment of the present disclosure.

Referring to FIG. 4, the electronic device 100 may output a circular gesture UI to the display 160 in operation 401. For example, the electronic device 100 may output the circular gesture UI while outputting, to the display 160, content in response to a request for playback of the content having a certain duration. Alternatively, the electronic device 100 may output the circular gesture UI, if the electronic device 100 receives a request to output the circular gesture UI while playing certain content.

The electronic device 100 may determine whether an event is sensed in a certain area in operation 403. For example, at least one of a certain area may be provided to an area inside or outside the circular gesture UI. For example, the certain area may include a first area (e.g., −15 to 15 degrees), a second area (e.g., 75 to 105 degrees), a third area (e.g., 165 to 195 degrees), and a fourth area (e.g., 255 degrees to 285 degrees) based on a center point of a circular gesture UI. The angular ranges may become narrower or wider depending on a design method. Furthermore, there may be more or fewer certain areas. The center point may be calculated based on arbitrary coordinates on the display 160. For example, the center point may be calculated based on pre-stored coordinates or coordinates obtained by a previous touch gesture. In this case, the certain area may include certain angular ranges for each orientation (e.g., north, south, east, or west) based on the center point. The certain area may be certain parts of a circular track object included in the circular gesture UI or certain ranges including the certain parts.

The certain area may vary with a touch occurrence point. For example, the certain area may include certain areas based on any one of the touch occurrence point or a new center point newly calculated in relation to the touch occurrence point. The electronic device 100 may receive a touch event on the display 160 in relation to the circular gesture UI. The electronic device 100 may check a position of the received touch event, and may determine whether the position is within the certain area.

If the touch event is received through the certain area, the electronic device 100 may display an indicator so that the indicator is continuous along a movement direction of the touch event with reference to the certain area in operation 405. In this operation, the electronic device 100 may employ a locating function in response to reception of the event. For example, if a second touch event is received through the third area within a certain time after a first touch event is received through the first area, the electronic device 100 may move the indicator from an initial position (e.g., a 0-degree position on the circular gesture UI) of the indicator to a certain position (e.g., a 180-degree position on the circular gesture UI) by as much as a certain angle (e.g., a unit of an angle of 15 degrees). In this case, the electronic device 100 may move a location point by a length corresponding to a 180-degree angular movement. For example, in the case where a setting is configured such that a playback length of two seconds is moved for each unit change of 15 degrees, the electronic device 100 may output corresponding content playback information to a locating position to which a total of 24 seconds have been moved.

If a touch event is received through an area outside the certain area, the electronic device 100 may display the indicator according to a certain unit and may employ a locating function in operation 407. For example, a first touch event may be received at a 0-degree position on the first area (e.g., −15 to 15 degrees) of the circular gesture UI, and, within a certain time, a second touch event may be received at a certain position on an area outside the certain area, for example, a 20-degree position. In this case, the electronic device 100 may move the indicator according to a certain unit (e.g., an angle of 15 degrees) change. Furthermore, the electronic device 100 may output content information to a locating position to which a playback length (e.g., two seconds) corresponding to the certain unit change has been moved.

The electronic device 100 may determine whether an event (e.g., a locating event) has ended in operation 409. If the locating event is not ended, for example, if the event continues to occur in relation to the circular gesture UI, the process may return to operation 403 so that the electronic device 100 may re-perform operation 403 and the following operations. When the event has ended, the electronic device 100 may remove the circular gesture UI from the display 160 in operation 411. Accordingly, the electronic device 100 may output a certain content playback screen to the display 160, or may output, to the display 160, a screen displayed prior to output of the circular gesture UI. The circular gesture UI may be output so as to be overlaid on a previous screen, and may have a smaller size than that of the previous screen. Accordingly, when the event has ended, the previous screen from which the circular gesture UI has been removed may be displayed on the display 160.

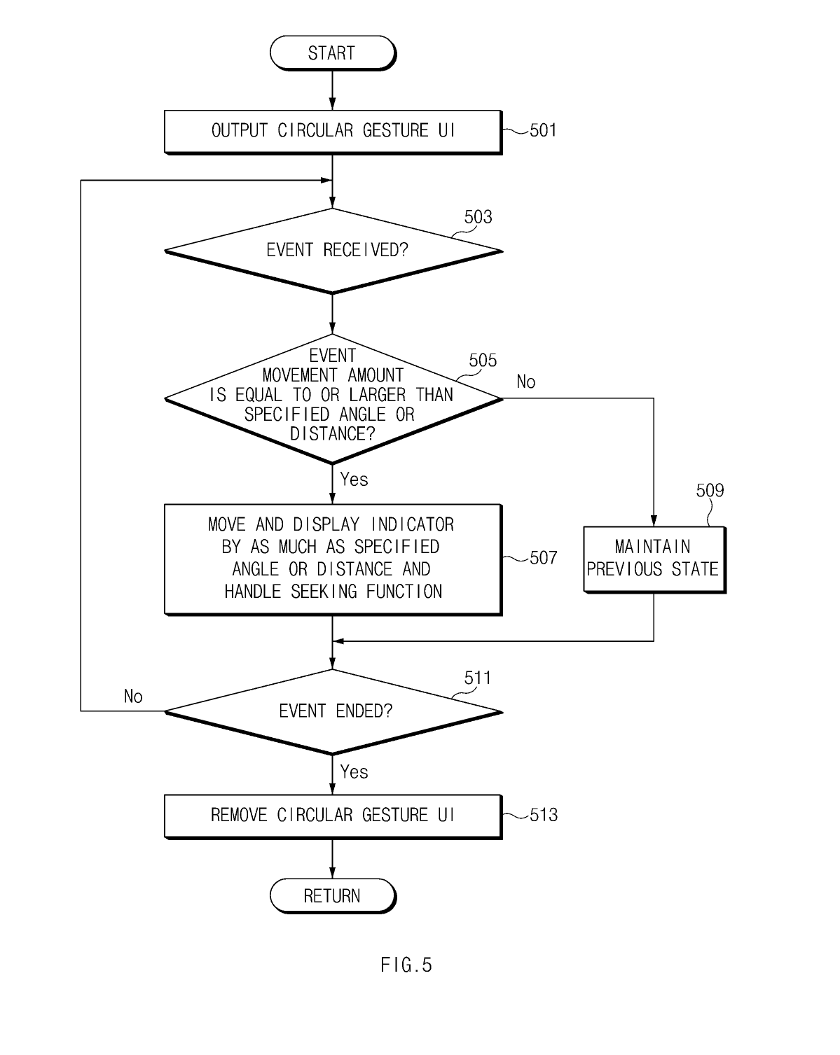

FIG. 5 is a flowchart of a correction method related to operating a circular gesture UI according to an embodiment of the present disclosure.

Referring to FIG. 5, the electronic device 100 may output the circular gesture UI in operation 501.

The electronic device 100 may determine whether an event is received in operation 503. If there is no event received, the process may proceed to operation 509. If the event is received, the electronic device 100 may determine whether an event movement amount is greater than or equal to a certain angle or distance in operation 505. If the event movement amount is equal to or larger than the specified angle or distance, the electronic device 100 may move an indicator by as much as a specified unit angle or distance and may employ a locating function in operation 507. If the event movement amount is less than the certain angle or distance, the electronic device 100 may maintain a previous state, for example, a previous display state of the indicator in operation 509.

The electronic device 100 may determine whether an event has ended in operation 511. If the event related to the operation of the locating function is not ended, the process may return to operation 503 so that the electronic device 100 may re-perform operation 503 and the following operations. If the event related to the operation of the locating function has ended, the electronic device 100 may remove the circular gesture UI in operation 513. For example, the electronic device 100 may output a content playback screen from which the circular gesture UI has been removed. In operation 513, the electronic device 100 may automatically play content that was paused during the operation of the circular gesture UI.

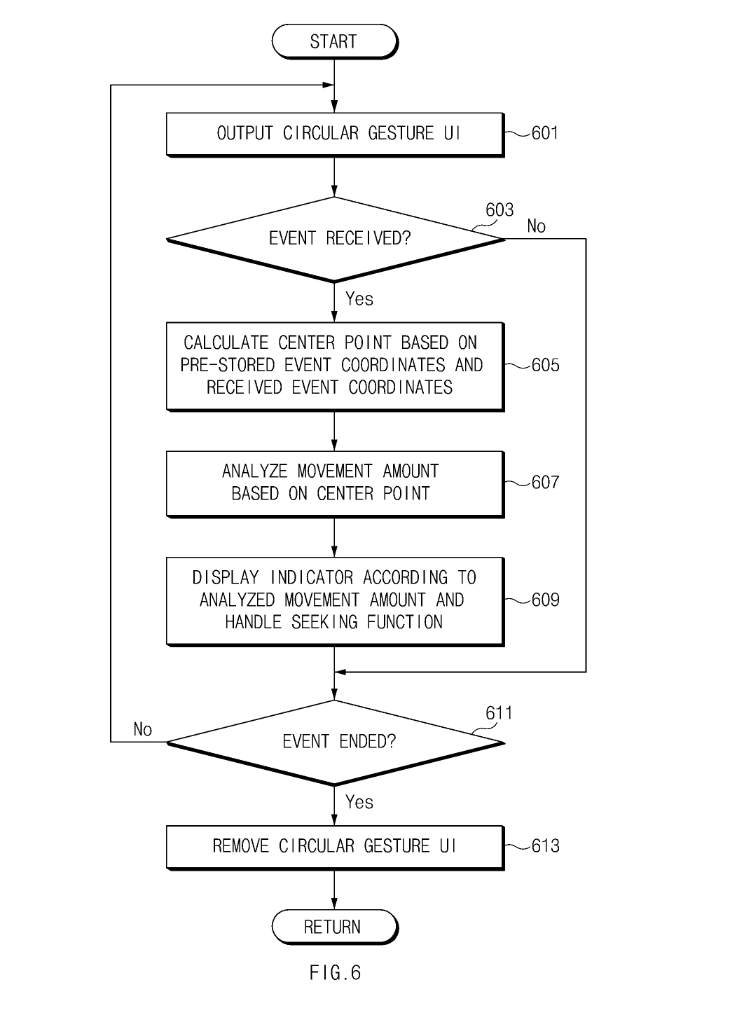

FIG. 6 is a flowchart of a method of operating a center point of a circular gesture UI according to an embodiment of the present disclosure.

Referring to FIG. 6, the electronic device 100 may output the circular gesture UI in operation 601. In operation 601, the electronic device 100 may output the circular gesture UI to a certain portion of the display 160 (e.g., a center, a lower center, or a lower right corner of the screen).

The electronic device 100 may determine whether an event is received in operation 603. If there is no event received, the process may proceed to operation 611 so that the electronic device 100 may perform operation 611 and the following operations. If the event is received, the electronic device 100 may calculate the center point based on pre-stored event coordinates and received event coordinates in operation 605. For example, in relation to an output of the circular gesture UI, the electronic device 100 may calculate center points of events based on previously collected event coordinates and currently received event coordinates. If there are no previously collected event coordinates, the electronic device 100 may apply arbitrary event coordinates (e.g., randomly selected coordinates or screen center coordinates). The electronic device 100 may calculate the center point by integrating 99 coordinates and currently received event coordinates. Calculation of a center point may be performed in such a manner that a certain rectangle is drawn by integrating coordinates and a center of the rectangle is determined as the center point of the coordinates. Alternatively, the calculation of the center point may be performed by selecting intermediate points that connect two coordinates.

The electronic device 100 may analyze a movement amount based on the center point in operation 607. For example, the electronic device 100 may calculate a movement direction, a traveled distance, or a movement angle of a touch and drag event that currently occurs based on the center point calculated from touch events instead of the center point of the circular gesture UI.

The electronic device 100 may display an indicator and employ a locating function according to an analyzed movement amount in operation 609. For example, the electronic device 100 may determine whether a calculated movement angle is greater than or equal to a certain unit angle, and may move the indicator on the display in a calculated movement direction. In this case, the electronic device 100 may also change a content locating position.

The electronic device 100 may determine whether an event has ended in operation 611. If reception of an event continues, the process may return to operation 601 so that the electronic device 100 may re-perform operation 601 and the following operations. If the reception of an event has ended, the electronic device 100 may remove the circular gesture UI in operation 613.

As described above, even if a touch event occurs on an area outside an area in which the circular gesture UI is disposed, the electronic device 100 may recognize the touch event as a valid touch event, and may display the indicator and employ the locating function according to the touch event.

A content locating function operating method may include outputting a circular gesture UI including a circular track object, receiving a touch gesture which occurs over a plurality of certain areas while the circular gesture UI is displayed, and moving and displaying an indicator along an arc path of the circular track object corresponding to an arc path passing through the plurality of areas.

The method may further include calculating an arbitrary center point by integrating pre-stored touch coordinates and currently received touch coordinates.

The method may further include setting (or allowing) a plurality of areas corresponding to certain angular ranges of at least one orientation based on the center point.

The method may further include setting (or allowing) a plurality of areas corresponding to a certain range in certain directions based on the center point related to an occurrence point of a touch gesture.

Moving and displaying may include moving and displaying an indicator along a 180-degree arc path in response to a touch gesture which occurs over areas of north and south orientations or east and west orientations or moving and displaying the indicator along a 90-degree arc path in response to a touch gesture which occurs over areas corresponding to a 90-degree orientation.

Moving and displaying may include moving and displaying an indicator by as much as a certain angular unit.

The method may further include changing a color of at least a part of the circular track object corresponding to the arc path.

The method may further include outputting playback information corresponding to a location point of content being played according to a traveled distance of the indicator.

Outputting may include outputting playback information corresponding to a location point of content to which an indicator's traveled distance is applied based on a location length set at a certain unit angle or distance.

Moving and displaying may include displaying an indicator at an adjacent area to a circular track object in response to a touch gesture such that the indicator is moved by as much as an angle or a distance corresponding to a certain movement amount value, if the touch gesture stops moving at an area outside certain areas or the touch gesture, a movement amount of which exceeds a certain value, occurs within a certain time at an area outside certain areas.

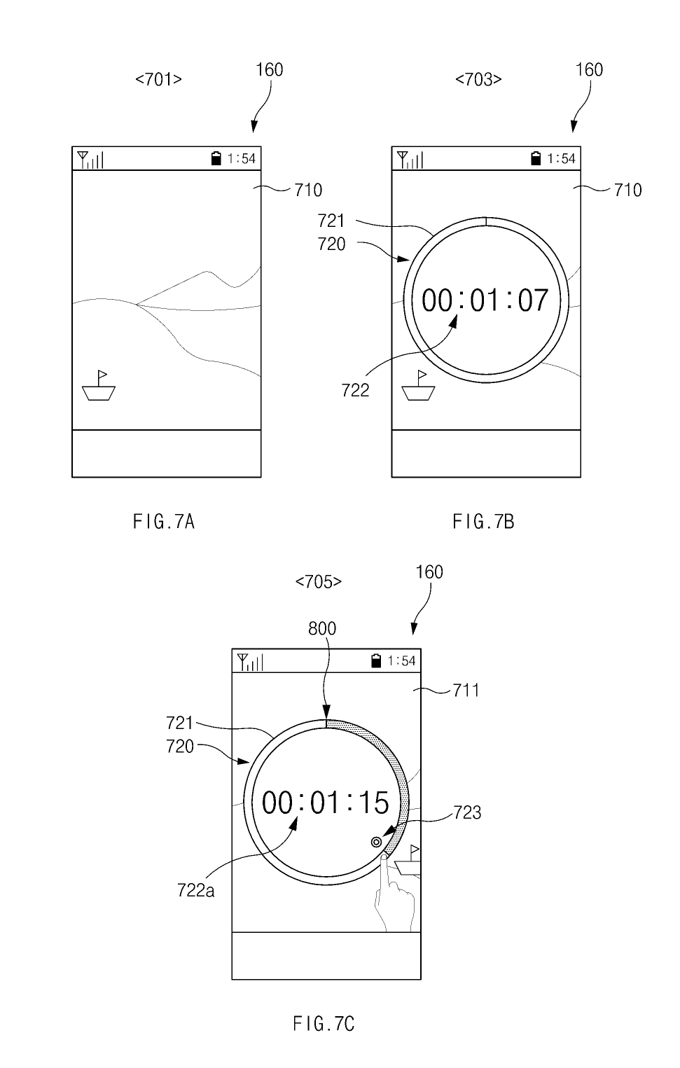

FIGS. 7A to 7C are diagrams of a screen interface of a circular gesture UI according to an embodiment of the present disclosure.

Referring to FIGS. 7A to 7C, the electronic device 100 may output, to the display 160, a playback area 710 of certain content (e.g., video content) according to a user input or a certain schedule as shown in a state 701 in FIG. 7A.

If an event of requesting output of a circular gesture UI occurs, the electronic device 100 may output a circular gesture UI 720 as shown in state 703 of FIG. 7B. For example, the electronic device 100 may overlay the circular gesture UI 720 on the content playback area 710. The circular gesture UI 720, for example, may include a circular track object 721 and a location time display object 722. If the circular gesture UI 720 is output, the electronic device 100 may pause playback of the content, and may output a paused screen to the content playback area 710. Alternatively, in a case where only the circular gesture UI 720 is output, the electronic device 100 may continue to play and output the content. If an event related to manipulation of the circular gesture UI 720 occurs, the electronic device 100 may pause the playback of the content.

If an event related to operation of the circular gesture UI 720 occurs, the electronic device 100 may change a display state of the circular gesture UI 720 as shown in state 705 of FIG. 7C. For example, the electronic device 100 may output an indicator 723 in response to an occurrence of an event. Furthermore, in response to the occurrence of the event, the electronic device 100 may change at least one of a color, a brightness, or a shape of the circular track object 721. In response to the occurrence of the event, the electronic device 100 may change a content location position, and may output content playback information corresponding to the changed position. An event which corresponds to an angular change of 120 degrees or more may occur for a certain time, in the state in which a setting is configured such that a playback point is changed by as much as a playback length of one second in response to an occurrence of an event of a 15-degree change. In response to an occurrence of an event related to an angular change, the electronic device 100 may output a content locating area 711 corresponding to a location position at which a playback time is 8 seconds later than that of the previous position. Furthermore, the electronic device 100 may output the indicator 723 to a position spaced apart from a starting point 800 by a certain distance. Furthermore, the electronic device 100 may change a color of a part of the circular track object 723 which is within a certain range (e.g., 120 degrees) from the starting point 800 of the circular track object 721. The electronic device 100 may output, to a certain area on the circular gesture UI 720, a location time display object 722a with the changed location point.

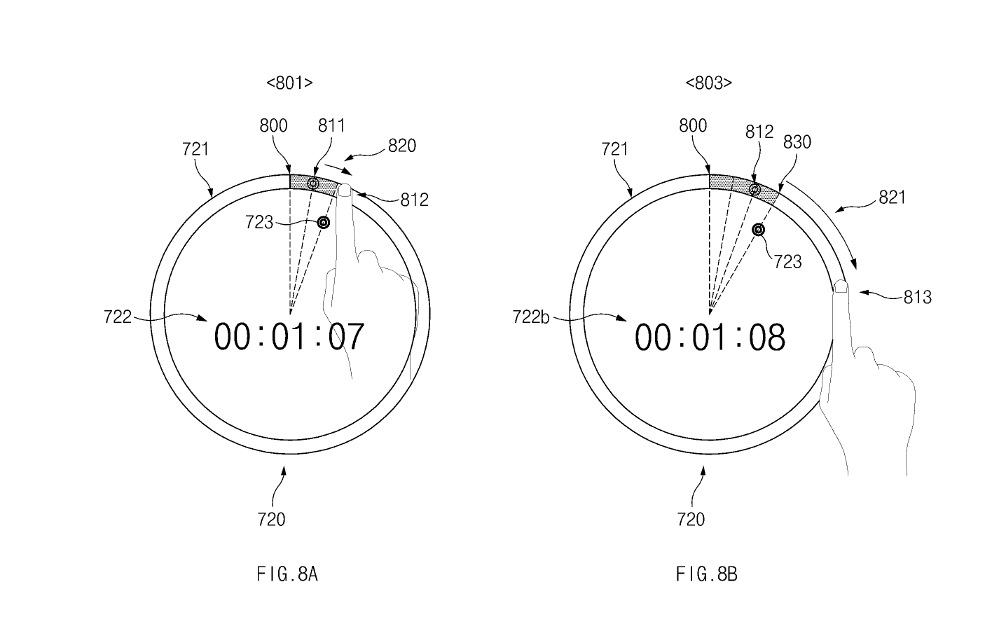

FIGS. 8A and 8B are diagrams of a screen interface related to correction of a circular gesture UI according to an embodiment of the present disclosure.

Referring to FIGS. 8A and 8B, the electronic device 100 may output the circular gesture UI 720 as shown in state 801 of FIG. 8A. The circular gesture UI 720, for example, may be output to locate content played continuously. The circular gesture UI 720 may include the circular track object 721 in which an area for displaying a location position is provided as a circular track, the indicator 723 for indicating a location position, and the location time display object 722 for indicating a location time. The circular track object 721, for example, may include a band-type object having a certain thickness. At least a part of the circular track object 721 may differ in color from another part thereof as a location event is received. The color change starting point 800 of the circular track object 721 may be specified, but may be changed according to a user setting. The starting point 800, for example, may overlap a location path as the seek event occurs. Accordingly, the starting point 800 of the circular track object 721 may overlap the endpoint according to the movement amount of the location event.

A touch event, which starts at a certain point on the circular track object 721 (or a certain portion of the display 160 to which the circular gesture UI 720 is output), for example, the starting point 800, and moves to a second touch event point 812 via a first touch event point 811, may occur. If the touch event occurs at the starting point 800, the electronic device 100 may output the indicator 723 to an adjacent area to the starting point 800, for example, a certain portion inside the circular track object 721. If a touch gesture passes through the first touch event point 811, the electronic device 100 may remove the indicator 723 displayed at the starting point 800, and may output the indicator 723 to an adjacent area to the first touch event point 811. If the touch gesture moves by as much as a unit movement amount 820 within a certain time and passes through the second touch event point 812, the electronic device 100 may remove the indicator 723 displayed on the adjacent area to the first touch event point 811, and may display the indicator 723 to an adjacent area to the second touch event point 812.

After passing through the second touch event point 812, the touch gesture may move by as much as a movement amount 821 greater than the unit movement amount within a certain time and may arrive at a third touch event point 813. In this case, as shown in a state 803 in FIG. 8B, the electronic device 100 may output the indicator 723 to an area 830 according to the unit movement amount. For example, the electronic device 100 may treat a movement amount which is greater than the unit movement amount as the unit movement amount, and may display the indicator 723 at a position spaced apart from a previous position by a certain angle or distance. Furthermore, the electronic device 100 may apply a different color only within an interval between the starting point 800 and the third touch event point 813. The electronic device 100 may change the location time object in response to a touch gesture input. For example, after outputting the first seek time object 722 as the touch gesture passes through the second touch event point 812, the electronic device 100 may output a second seek time object 722b if the touch gesture passes through the third touch event point 813.

After a color change, which starts at the starting point 800, is applied to the circular gesture UI 720, the electronic device 100 may stop the color change of the circular track object 721 and may only determine a position change of the indicator 723. After the electronic device 100 applies a color change over the entirety of the circular track object 721 starting from the starting point 800, the electronic device 100 may apply another color in response to an additional touch gesture input.

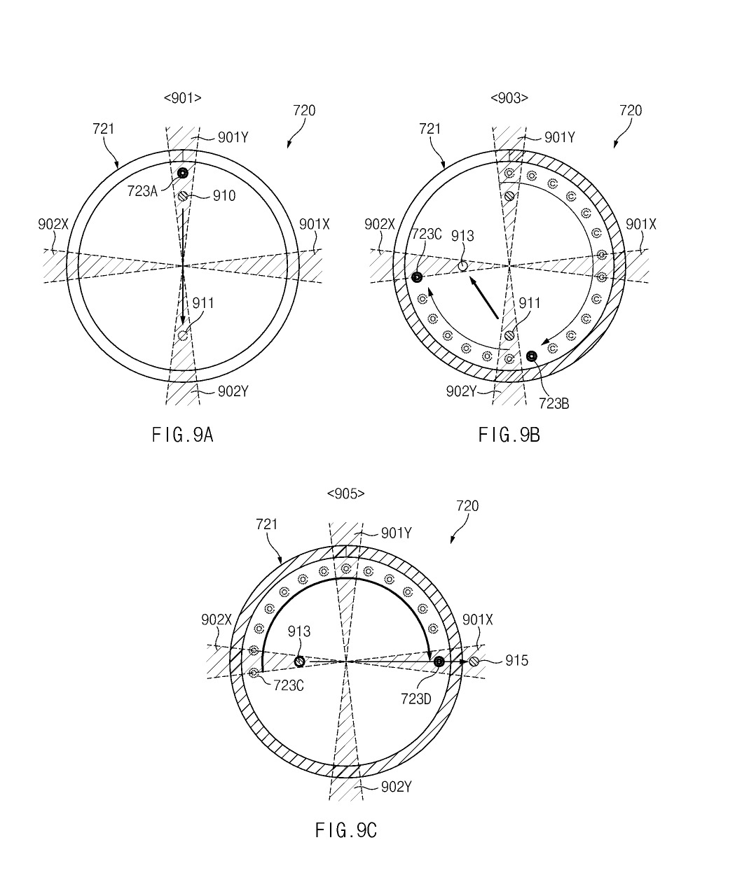

FIGS. 9A to 9C are diagrams of a screen interface related to a display of an indicator of a circular gesture UI according to an embodiment of the present disclosure.

Referring to FIGS. 9A to 9C, the electronic device 100 may output a circular gesture UI 720 to the display 160 according to a user input or set schedule information (e.g., a playback start point of video content, or the like). In this operation, the electronic device 100 may output the circular track object 721, and may output a first indicator 723A to an adjacent area to the circular track object 721 in response to a touch gesture input for a location operation. Additionally or alternatively, the electronic device 100 may output a location time object (e.g., information for displaying a time of a playback position of content that is currently being located).

When outputting the circular track object 721, the electronic device 100 may set certain areas 901Y, 902Y, 901X, and 902X as shown in a state 901. The specified areas 901Y, 902Y, 901X, and 902X, for example, may include a first area 901Y corresponding to a first angular range of a first orientation based on a center point of the circular track object 721, a second area 902Y corresponding to the first angular range of a second orientation (e.g., an opposite orientation to the first orientation with respect to the center point), a third area 901X corresponding to the first angular range of a third orientation (e.g., a perpendicular orientation to the first orientation), and a fourth area 902X corresponding to the first angular range of a fourth orientation (e.g., an opposite orientation to the third orientation with respect to the center point). The areas 901Y, 902Y, 901X, and 902X may include certain areas of an inner side, a track, and an outer side of the circular track object 721. Accordingly, even if a touch gesture occurs on an area outside the circular track object 721, the electronic device 100 may detect a touch event occurring on the areas 901Y, 902Y, 901X, and 902X.

As described above, in a case where touch center points are calculated based on previously detected touch coordinates, the areas 901Y, 902Y, 901X, and 902X may be defined in relation to a center point calculated based on previously detected touch coordinates regardless of the circular track object 721 displayed on the display 160. The areas may include a certain angular range corresponding to at least one orientation based on a certain center point on the display 160. An orientation, for example, may include not only four orientations of north, south, east, and west but may also include further detailed orientations such as 8 or 16 orientations.

If a touch gesture (e.g., a touchdown event) occurs on a first touch event point 910 on the first area 901Y, the electronic device 100 may output the first indicator 723A to a certain point on the circular track object 721 (e.g., a certain point at the inner side of the circular track object 721 in the north orientation). The touch gesture may be changed into a drag gesture and may move to a second touch event point 911. For example, the touch gesture may occur in a vertical direction from the first area 901Y to the second area 902Y without passing through other areas.

If a touch gesture dragged from the first area 901Y to the second area 902Y occurs, the electronic device 100 may move and display the first indicator 723A to a position of a second indicator 723B as shown in a state 903. For example, the electronic device 100 may display an indicator at the inner side of the circular track object 721 such that the indicator is moved and displayed along an arc path extending from the first area 901Y to the third area 901X and an arc path extending from the third area 901X to the second area 902Y (e.g., a range of 180 degrees). When moving and displaying an indicator, the electronic device 100 may move the indicator by as much as a certain unit angle (e.g., an angle of 15 degrees) at one time. The electronic device 100 may move and display the first indicator to the second indicator position in proportion to a Y-axial traveled distance of the touch gesture. For example, the electronic device 100 may display a traveled distance of the first indicator in proportion to the Y-axial traveled distance differently. The electronic device 100 may display a movement speed of the first indicator in proportion to the Y-axial traveled distance per unit time differently.

The position of a touch gesture may be changed from the second touch event point 911 to a third touch event point 913 (e.g., a certain point on the fourth area 902X) within a certain time as shown in a state 905. The electronic device 100 may move and display the second indicator 723B positioned at the inner side of the circular track object 721 along an arc path extending from the second area 902Y to the fourth area 902X (e.g., a range of 90 degrees), and then may display a third indicator 723C. In this case, the electronic device 100 may move and display the indicator for each angle.

A touch gesture may occur from the third touch event point 913 to a fourth touch event point 915 (e.g., a certain point on the third area 901X) within a certain time as shown in state 905 of FIG. 9C. The electronic device 100 may move and display the third indicator 723C positioned at the inner side of the circular track object 721 along an arc path extending from the fourth area 902X to the third area 901X, and then may display a fourth indicator 723D. In this case, the electronic device 100 may move and display the indicator for each angle. The electronic device 100 may move an indicator in proportion to an X-axial traveled distance. For example, the electronic device 100 may display the traveled distance of the first indicator in proportion to the X-axial traveled distance differently. The electronic device 100 may display the movement speed of the first indicator in proportion to the X-axial traveled distance per unit time differently.

The function described above with reference to FIGS. 8A and 8B may be applied to an area outside certain areas. For example, if an event movement amount which is greater than or equal to a certain value occurs between the first area 901Y and the second area 902Y, the electronic device 100 may treat the event movement amount as a certain unit movement amount. For example, if a movement amount which is greater than or equal to a certain value occurs between the above-mentioned areas, the electronic device 100 may display the indicator by moving the indicator by as much as only a certain unit (e.g., an angle of 15 degrees).

A direction in which an indicator is moved and displayed may be determined according to a direction of entry to certain areas. For example, after a touch gesture occurs in a direction from a left side of the first area 901Y to a right side of the first area 901Y, the electronic device 100 may receive a touch gesture which moves towards the second area 902Y. In this case, the electronic device 100 may move and display the indicator along an arc path which starts at the right side of the first area 901Y (e.g., a right-side arc path of the circular track object 721) and leads to the second area 902Y. After a touch gesture occurs in a direction from the right side of the first area 901Y to the left side of the first area 901Y, the electronic device 100 may receive a touch gesture which moves towards the second area 902Y. In this case, the electronic device 100 may move and display the indicator along an arc path which starts at the left side of the first area 901Y (e.g., a left-side arc path of the circular track object 721) and leads to the second area 902Y. If a touch gesture which moves back towards the fourth area 902X occurs after occurrence of a fourth touch event 915, and a touch event is received through the fourth area 902X, the electronic device 100 may move and display the indicator along an arc path below the third area 901X and the fourth area 902X.

The processor of the electronic device 100 may output playback information corresponding to a seek point of content being played, according to the indicator's movement amount (e.g., a traveled distance or a rotated angle of the indicator due to occurrence of a touch gesture). In this case, the processor of the electronic device 100 may output playback information corresponding to the location point of the content to which the indicator's movement amount is applied based on a location length (e.g., one second or two seconds per 15 degrees) set as a certain unit angle or unit distance.

The above description is provided with respect to an example in which the indicator is output in relation to certain areas touched by a touch gesture, but the present disclosure is not limited thereto. For example, the electronic device 100 may display, on the display, a graphical user interface (GUI) representing the starting point, the endpoint, and an indicator, wherein the starting point and the endpoint overlap or are proximate to each other, wherein the indicator is shown on a path formed between the starting point and the endpoint. The electronic device 100 may receive a first gesture input through the display, and may move the indicator on the path based on a first component of the first gesture input if the first component parallel to a first side of the display is substantially greater than a second component parallel to a second side of the display among components forming the first gesture input. The electronic device 100 may move the indicator on the path based on the second component if the second component is substantially greater than the first component among the components. For example, if a touch gesture occurs along an X-axis, a Y-axis, or a diagonal line (e.g., a touch gesture which swings with respect to a certain axis of a GUI center point), the electronic device 100 may move and display the indicator on the path based on a certain component.

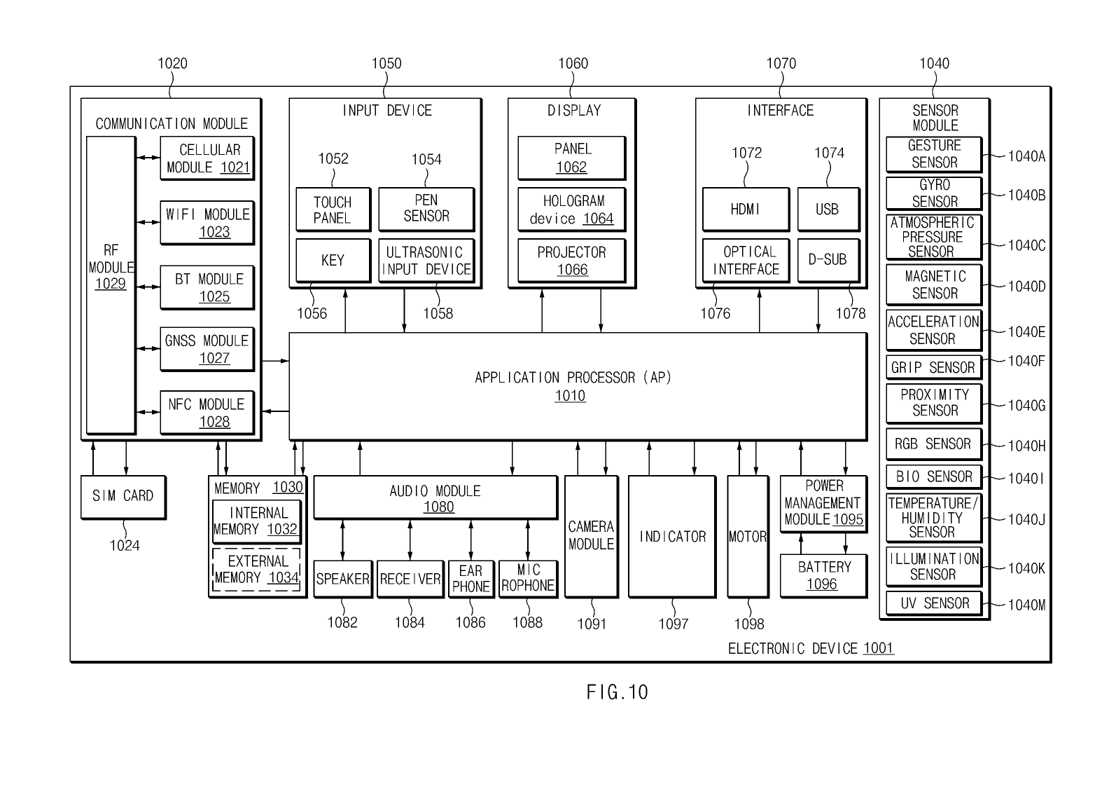

FIG. 10 is a block diagram of an electronic device according to an embodiment of the present disclosure.

Referring to FIG. 10, an electronic device 1001 may include, for example, a part or the entirety of the electronic device described above. The electronic device 1001 may include at least one processor (e.g., an AP) 1010, a communication module 1020, a subscriber identification module (SIM) card 1024, a memory 1030, a sensor module 1040, an input device 1050, a display 1060, an interface 1070, an audio module 1080, a camera module 1091, a power management module 1095, a battery 1096, an indicator 1097, and a motor 1098.

The at least one processor 1010 may run an operating system or an application program so as to control a plurality of hardware or software elements connected to the at least one processor 1010, and may process various data and perform operations. The at least one processor 1010 may be implemented with, for example, a system on chip (SoC). According to an embodiment of the present disclosure, the at least one processor 1010 may further include a graphics processing unit (GPU) and/or an image signal processor. The at least one processor 1010 may include at least a portion (e.g., a cellular module 1021) of the elements illustrated in FIG. 10. The at least one processor 1010 may load, on a volatile memory, an instruction or data received from at least one of the other elements (e.g., a nonvolatile memory) to process the instruction or data, and may store various data in a nonvolatile memory.

The communication module 1020 may have a configuration that is the same as or similar to that of the communication interface 170 of FIG. 1. The communication module 1020 may include, for example, a cellular module 1021, a Wi-Fi module 1023, a Bluetooth module 1025, a GNSS module 1027 (e.g., a GPS module, a GLONASS module, a BeiDou module, or a Galileo module), a near field communication (NFC) module 1028, and a radio frequency (RF) module 1029. In addition, the communication module 1020 may further include an MST module.

The cellular module 1021 may provide, for example, a voice call service, a video call service, a text message service, or an Internet service through a communication network. The cellular module 1021 may identify and authenticate the electronic device 1001 in the communication network using the SIM card 1024. The cellular module 1021 may perform at least a part of functions providable by the at least one processor 1010. The cellular module 1021 may include a CP.

Each of the Wi-Fi module 1023, the Bluetooth module 1025, the GNSS module 1027, and the NFC module 1028 may include, for example, a processor for processing data transmitted/received through the modules. According to an embodiment of the present disclosure, at least a portion (e.g., at least two) of the cellular module 1021, the Wi-Fi module 1023, the Bluetooth module 1025, the GNSS module 1027, and the NFC module 1028 may be included in a single integrated circuit (IC) or IC package.

The RF module 1029 may transmit/receive, for example, communication signals (e.g., RF signals). The RF module 1029 may include, for example, a transceiver, a power amplifier module (PAM), a frequency filter, a low noise amplifier (LNA), an antenna, or the like. According to another embodiment of the present disclosure, at least one of the cellular module 1021, the Wi-Fi module 1023, the Bluetooth module 1025, the GNSS module 1027, or the NFC module 1028 may transmit/receive RF signals through a separate RF module.

The SIM card 1024 may include unique identification information (e.g., an integrated circuit card identifier (ICCID)) or subscriber information (e.g., an international mobile subscriber identity (IMSI)).

The memory 1030 (e.g., the memory 100) may include an internal memory 1032 or an external memory 1034. The internal memory 1032 may include at least one of a volatile memory (e.g., a dynamic random access memory (DRAM), a static RAM (SRAM), a synchronous dynamic RAM (SDRAM), or the like) or a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, or the like), a hard drive, or a solid state drive (SSD)).

The external memory 1034 may include a flash drive, for example, a compact flash (CF) drive, a secure digital (SD) drive, a micro secure digital (Micro-SD) drive, a mini secure digital (Mini-SD) drive, an extreme digital (xD) drive, a multi-media card (MMC), a memory stick, or the like. The external memory 1034 may be operatively and/or physically connected to the electronic device 1001 through various interfaces.

The electronic device 1001 may further include a security module. The security module, which is a high-security module as compared to the memory 1030, may be a circuit that guarantees secure storage of data and provides a protected execution environment. The security module may be implemented with a separate circuit, and may include a separate processor. The security module may include, for example, an embedded secure element (eSE) embedded in a fixed IC of the electronic device 1001 or may be present in a detachable smart IC or secure digital (SD) drive. The security module may be driven by an operating system (OS) different from an OS of the electronic device 1001. For example, the security module may be operated based on a java card open platform (JCOP) OS.

The sensor module 1040 may, for example, measure a physical quantity or detect an operation state of the electronic device 1001 so as to convert measured or detected information into an electrical signal. The sensor module 1040 may include, for example, at least one of a gesture sensor 1040A, a gyro sensor 1040B, an atmospheric pressure sensor 1040C, a magnetic sensor 1040D, an acceleration sensor 1040E, a grip sensor 1040F, a proximity sensor 1040G, a color sensor 1040H (e.g., a red/green/blue (RGB) sensor), a biometric (or bio) sensor 1040I, a temperature/humidity sensor 1040J, an illumination sensor 1040K, or an ultraviolet (UV) light sensor 1040M. Additionally or alternatively, the sensor module 1040 may include, for example, an olfactory sensor (e.g. an electronic nose (E-nose) sensor), an electromyography (EMG) sensor, an electroencephalogram (EEG) sensor, an electrocardiogram (ECG) sensor, an infrared (IR) sensor, an iris sensor, and/or a fingerprint sensor. The sensor module 1040 may further include a control circuit for controlling at least one sensor included therein. In an embodiment of the present disclosure, the electronic device 1001 may further include a processor configured to control the sensor module 1040 as a part of the at least one processor 1010 or separately, so that the sensor module 1040 is controlled while the at least one processor 1010 is in a sleep state.

The input device 1050 may include, for example, a touch panel 1052, a (digital) pen sensor 1054, a key 1056, or an ultrasonic input device 1058. The touch panel 1052 may employ at least one of a capacitive method, a resistive method, an infrared method, and an ultraviolet sensing method. The touch panel 1052 may further include a control circuit. The touch panel 1052 may further include a tactile layer so as to provide a haptic feedback to a user.

The (digital) pen sensor 1054 may include, for example, a sheet for recognition which is a part of a touch panel or may be separate. The key 1056 may include, for example, a physical button, an optical button, or a keypad. The ultrasonic input device 1058 may sense ultrasonic waves generated by an input tool through a microphone (e.g., a microphone 1088) so as to identify data corresponding to the ultrasonic waves sensed.

The display 1060 (e.g., the display 160) may include a panel 1062, a hologram device 1064, or a projector 1066. The panel 1062 may have a configuration that is the same as or similar to that of the display 160 of FIG. 2. The panel 1062 may be, for example, flexible, transparent, or wearable. The panel 1062 and the touch panel 1052 may be integrated into a single module. The hologram device 1064 may display a stereoscopic image in a space using a light interference phenomenon. The projector 1066 may project light onto a screen so as to display an image. The screen may be disposed internally or externally to the electronic device 1001. The display 1060 may further include a control circuit for controlling the panel 1062, the hologram device 1064, or the projector 1066.

The interface 1070 may include, for example, a high-definition multimedia interface (HDMI) 1072, a universal serial bus (USB) 1074, an optical interface 1076, or a D-subminiature (D-sub) connector 1078. The interface 1070, for example, may be included in the communication interface 170 illustrated in FIG. 1. Additionally or alternatively, the interface 1070 may include, for example, a mobile high-definition link (MHL) interface, an SD card/multi-media card (MMC) interface, or an Infrared Data Associated (IrDA) interface.

The audio module 1080 may convert, for example, a sound into an electrical signal or vice versa. At least a portion of elements of the audio module 1080 may be included in the input/output interface 150 illustrated in FIG. 1. The audio module 1080 may process sound information input or output through a speaker 1082, a receiver 1084, an earphone 1086, or the microphone 1088.

The camera module 1091 for shooting a still image or a video may include, for example, at least one image sensor (e.g., a front sensor or a rear sensor), a lens, an image signal processor (ISP), or a flash (e.g., an LED or a xenon lamp).

The power management module 1095 may manage power of the electronic device 1001. According to an embodiment of the present disclosure, the power management module 1095 may include a power management integrated circuit (PMIC), a charger IC, or a battery gauge. The PMIC may employ a wired and/or a wireless charging method. The wireless charging method may include, for example, a magnetic resonance method, a magnetic induction method, an electromagnetic method, or the like. An additional circuit for wireless charging, such as a coil loop, a resonant circuit, a rectifier, or the like, may be further included. The battery gauge may measure, for example, a remaining capacity of the battery 1096 and a voltage, current or temperature thereof while the battery 1096 is charged. The battery 1096 may include, for example, a rechargeable battery and/or a solar battery.

The indicator 1097 may display a certain state of the electronic device 1001 or a part thereof (e.g., the at least one processor 1010), such as a booting state, a message state, a charging state, or the like. The motor 1098 may convert an electrical signal into a mechanical vibration, and may generate a vibration or haptic effect. A processing device (e.g., a GPU) for supporting a mobile TV may be included in the electronic device 1001. The processing device for supporting a mobile TV may process media data according to the standards of digital multimedia broadcasting (DMB), digital video broadcasting (DVB), MediaFLO™, or the like.

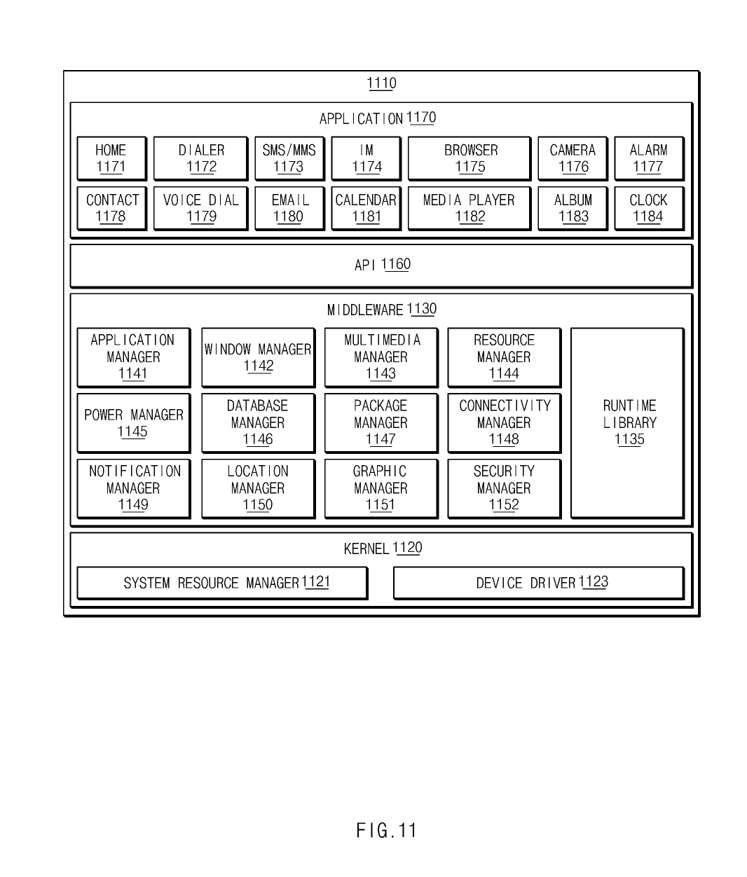

FIG. 11 is a block diagram of a program according to an embodiment of the present disclosure.

Referring to FIG. 11, a program module 1110 (e.g., the program 110) may include an OS for controlling a resource related to an electronic device (e.g., the electronic device 100) and/or various applications (e.g., the application program 117) running on the OS. The operating system may be, for example, Android®, iOS®, Windows®, Symbian™, Tizen®, Bada™, or the like.

The program module 1110 may include a kernel 1120, middleware 1130, an application programming interface (API) 1160, and/or an application 1170. At least a part of the program module 1110 may be preloaded on an electronic device or may be downloaded from the electronic device 102 or the server 104.

The kernel 1120 (e.g., the kernel 141) may include, for example, a system resource manager 1121 and/or a device driver 1123. The system resource manager 1121 may perform control, allocation, or retrieval of a system resource. According to an embodiment of the present disclosure, the system resource manager 1121 may include a process management unit, a memory management unit, a file system management unit, or the like. The device driver 1123 may include, for example, a display driver, a camera driver, a Bluetooth driver, a shared memory driver, a USB driver, a keypad driver, a Wi-Fi driver, an audio driver, or an inter-process communication (IPC) driver.

The middleware 1130, for example, may provide a function that the application 1170 requires in common, or may provide various functions to the application 1170 through the API 1160 so that the application 1170 may efficiently use limited system resources in the electronic device. According to an embodiment of the present disclosure, the middleware 1130 (e.g., the middleware 143) may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, or a security manager 1152.

The runtime library 1135 may include, for example, a library module that a complier uses to add a new function through a programming language while the application 1170 is running. The runtime library 1135 may perform a function for input/output management, memory management, or an arithmetic function.

The application manager 1171 may mange, for example, a life cycle of at least one of the applications in the application 1170. The window manager 1142 may manage a GUI resource used in a screen. The multimedia manager 1143 may recognize a format required for playing various media files and may encode or decode a media file using a codec matched to the format. The resource manager 1144 may manage a resource such as source code, a memory, or a storage space of at least one of the applications in the application 1170.

The power manager 1145, for example, may operate with a basic input/output system (BIOS) to manage a battery or power and may provide power information required for operating the electronic device. The database manager 1146 may generate, search, or modify a database to be used in at least one of the applications in the application 1170. The package manager 1147 may manage the installation or the update of an application distributed in a package file format.

The connectivity manger 1148 may manage a wireless connection of Wi-Fi, Bluetooth, or the like. The notification manager 1149 may display or notify of an event such as message arrival, appointments, and proximity alerts in such a manner as to not disturb a user. The location manager 1150 may manage location information of the electronic device. The graphic manager 1151 may manage a graphic effect to be provided to a user or a user interface related thereto. The security manager 1152 may provide various security functions required for system security or user authentication. In a case in which an electronic device (e.g., the electronic device 100) includes a phone function, the middleware 1130 may further include a telephony manager for managing a voice or video call function of the electronic device.

The middleware 1130 may include a middleware module for forming a combination of various functions of the above-mentioned elements. The middleware 1130 may provide a module configured for each type of an operating system to provide differentiated functions. Furthermore, the middleware 1130 may delete a part of existing elements or may add new elements dynamically.

The API 1160 (e.g., an API 145) which is, for example, a set of API programming functions, may be provided in different configurations according to an operating system. For example, in the case of Android® or iOS®, one API set may be provided for each platform, and, in the case of Tizen®, at least two API sets may be provided, one for each platform.

The application 1170 (e.g., the application program 147), for example, may include at least one application for performing functions such as a home application 1171, a dialer application 1172, a short message service/multimedia messaging service (SMS/MMS) application 1173, an instant message (IM) application 1174, a browser application 1175, a camera application 1176, an alarm application 1177, a contact application 1178, a voice dial application 1179, an e-mail application 1180, a calendar application 1181, a media player application 1182, an album application 1183, a clock application 1184, a payment application, a health care application (e.g., measure an amount of exercise or blood sugar level), or environmental information provision (e.g., provide air pressure, humidity, or temperature information).

The application 1170 may include an application (hereinafter referred to as an “information exchange application”) for supporting information exchange between the electronic device (e.g., the electronic device 100) and the server 104. The information exchange application may include, for example, a notification relay application for relaying certain information to an external device or a device management application for managing an external electronic device or an external device.

For example, the notification relay application may have a function for relaying, to the external electronic device 102, notification information generated in another application (e.g., an SMS/MMS application 1173, an e-mail application 1180, a health care application, an environmental information application, or the like) of the electronic device. Furthermore, the notification relay application may receive notification information from the external electronic device and may provide the received notification information to the user.

The device management application, for example, may manage (e.g., install, delete, or update) at least one function (e.g., turn-on/turn off of the external device itself (or some elements) or the brightness (or resolution) adjustment of a display) of the external electronic device 102 communicating with the electronic device, an application running in the external electronic device, or a service (e.g., a call service or a message service) provided from the external device.

The application 1170 may include a certain application (e.g., a healthcare application of a mobile medical device) according to an attribute of the external electronic device 102. The application 1170 may include an application received from the external electronic device 102 or the server 104. The application 1170 may include a preloaded application or a third-party application downloadable from a server. The names of the elements of the program module 1110 illustrated may vary with the type of an operating system.

At least a part of the program module 1110 may be implemented with software, firmware, hardware, or a combination thereof. At least a part of the program module 1110, for example, may be implemented (e.g., executed) by a processor (e.g., the processor 120). At least a part of the program module 1110 may include, for example, a module, a program, a routine, sets of instructions, or a process for performing at least one function.

Each of the elements described herein may be configured with one or more components, and the names of the elements may be changed according to the type of an electronic device. In an embodiment of the present disclosure, an electronic device may include at least one of the elements described herein, and some elements may be omitted or other additional elements may be added. Furthermore, some of the elements of the electronic device may be combined to form one entity, so that the functions of the elements may be performed in the same manner as before the combination.

The term “module” used herein may represent, for example, a unit including one of hardware, software and firmware or a combination thereof. The term “module” may be interchangeably used with the terms “unit,” “logic,” “logical block,” “component,” and “circuit.” The term “module” may indicate a minimum unit of an integrated component or may be a part thereof. The term “module” may indicate a minimum unit for performing one or more functions or a part thereof. The term “module” may indicate a device that may be implemented mechanically or electronically. For example, the term “module” may include at least one of an application-specific integrated circuit (ASIC) IC, a field-programmable gate array (FPGA), and a programmable-logic device for performing some operations, which are known or will be developed.

At least a part of devices (e.g., modules or functions thereof) or methods (e.g., operations) according to an embodiment of the present disclosure may be implemented as instructions stored in a non-transitory computer-readable storage medium in the form of a program module. In a case where instructions are performed by a processor (e.g., the processor 120), the processor may perform functions corresponding to the instructions. The non-transitory computer-readable storage medium may be, for example, the memory 130.

A non-transitory computer-readable recording medium may include a hard disk, a floppy disk, a magnetic medium (e.g., a magnetic tape), an optical medium (e.g., compact disc ROM (CD-ROM), digital video disc (DVD)), a magneto-optical medium (e.g., a floptical disk), or a hardware device (e.g., a ROM, a RAM, a flash memory, or the like). The program instructions may include machine language code generated by compilers and high-level language code that may be executed by computers using interpreters. The above-mentioned hardware device may be configured to be operated as one software module for performing operations of an embodiment of the present disclosure and vice versa.

An embodiment of the present disclosure may enable a user to locate a desired playback point of content as intended by the user using a circular gesture UI.

Furthermore, according to an embodiment of the present disclosure, a stable content locating function may be provided by correcting a circular gesture moving with an irregular trajectory.

A module or a program module according to an embodiment of the present disclosure may include at least one of the above-mentioned elements, or some elements may be omitted or other additional elements may be added. Operations performed by the module, the program module or other elements according to an embodiment of the present disclosure may be performed in a sequential, parallel, iterative or heuristic manner. Furthermore, some operations may be performed in another order or may be omitted, or other operations may be added. Each embodiment of the present disclosure is illustrative and is not limitative. Various alternatives and equivalents are possible. Other additions, subtractions, or modifications may be obvious in view of the present disclosure and are intended to fall within the scope of the present disclosure as defined by the appended claims and their equivalents.

What is claimed is:

1. An electronic device, comprising:
a memory configured to store a circular gesture user interface (UI) including a circular track object related to control of playback of a video; and
a processor electrically connected to the memory and
configured to receive a touch gesture event while the circular gesture UI is displayed on a display, and move and display an indicator along an arc path of the circular track object corresponding to an arc path passing through a plurality of areas in which the touch gesture event occurs.

2. The electronic device of claim 1, wherein the processor is further configured to calculate a center point by integrating pre-stored touch coordinates and currently received touch coordinates.

3. The electronic device of claim 2, wherein the processor is further configured to allow a plurality of areas corresponding to a certain angular range of at least one orientation based on the center point.

4. The electronic device of claim 2, wherein the processor is further configured to allow a plurality of areas corresponding to an angular range in directions based on the center point related to an occurrence point of a touch gesture.

5. The electronic device of claim 4, wherein the processor is further configured to:
move and display the indicator along a 180-degree arc path in response to a touch gesture which occurs over areas of north and south orientations or east and west orientations; or
move and display the indicator along a 90-degree arc path in response to a touch gesture which occurs over areas corresponding to an angle of 90 degrees.

6. The electronic device of claim 1, wherein the processor is further configured to move and display the indicator by as much as an angle at one time.

7. The electronic device of claim 1, wherein the processor is further configured to change a color of at least a part of the circular track object corresponding to the arc path.

8. The electronic device of claim 1, wherein the processor is further configured to output playback information corresponding to a location point of content being played according to a traveled distance of the indicator.

9. The electronic device of claim 8, wherein the processor is further configured to output the playback information corresponding to the location point of the content to which the traveled distance of the indicator is applied based on a location length set as a unit angle or distance.

10. The electronic device of claim 1, wherein, if a touch gesture stops moving at an area outside areas or the touch gesture, a movement amount of which exceeds a value, occurs within a specified time at the area outside the specified areas, the processor is configured to display the indicator at an adjacent area to the circular track object in response to the touch gesture such that the indicator is moved by as much as an angle or a distance corresponding to a movement amount value.

11. A content locating method, comprising:
outputting, by a processor, a circular gesture user interface (UI) including a circular track object related to playback of continuous information to a display;
receiving, by the processor, a touch gesture which occurs over a plurality of areas while the circular gesture UI is displayed; and
moving and displaying, by the processor, an indicator along an arc path of the circular track object corresponding to an arc path passing through the plurality of areas.

12. The content locating method of claim 11, further comprising calculating a center point by integrating pre-stored touch coordinates and currently received touch coordinates.

13. The content locating method of claim 12, further comprising setting a plurality of areas corresponding to an angular range of at least one orientation based on the center point.

14. The content locating method of claim 12, further comprising setting a plurality of areas corresponding to an angular range in directions based on the center point related to an occurrence point of a touch gesture.

15. The content locating method of claim 14, wherein moving and displaying, by the processor, the indicator along the arc path of the circular track object corresponding to the arc path passing through the plurality of areas comprises:
moving and displaying the indicator along a 180-degree arc path in response to a touch gesture which occurs over areas of north and south orientations or east and west orientations; or
moving and displaying the indicator along a 90-degree arc path in response to a touch gesture which occurs over areas corresponding to a 90-degree orientation.

16. The content locating method of claim 11, wherein moving and displaying, by the processor, the indicator along the arc path of the circular track object corresponding to the arc path passing through the plurality of areas comprises moving and displaying the indicator by as much as an angular unit at one time.

17. The content locating method of claim 11, further comprising at least one of:
changing a color of at least a part of the circular track object corresponding to the arc path; or
outputting playback information corresponding to a location point of content being played according to a traveled distance of the indicator.

18. The content locating method of claim 17, wherein outputting playback information corresponding to the location point of content being played according to the traveled distance of the indicator comprises outputting the playback information corresponding to the location point of the content to which the traveled distance of the indicator is applied based on a location length set as a unit angle or distance.

19. The content locating method of claim 11, wherein moving and displaying, by the processor, the indicator along the arc path of the circular track object corresponding to the arc path passing through the plurality of areas comprises displaying the indicator at an adjacent area to the circular track object in response to the touch gesture such that the indicator is moved by as much as an angle or a distance corresponding to a movement amount value, if the touch gesture stops moving at an area outside the areas or the touch gesture, a movement amount of which exceeds a specified value, occurs within a time at the area outside the areas.

20. An electronic device, comprising:
a touch screen display;
a processor; and a memory
configured to store at least a part of audio/video (A/V) data including a starting point and an endpoint and store instructions that, when executed, cause the processor to:
sequentially or continuously play, on the touch screen display, the at least the part of the AV data;
display, on the display, a graphical user interface (GUI) representing the starting point, the endpoint, and an indicator, wherein the starting point and the endpoint overlap or are proximate to each other, wherein the indicator is shown on a path formed between the starting point and the endpoint;
receive, through the touch screen display, a first gesture input which moves by a first distance or a first angle in a form which is the same as or similar to at least a part of the path; and
move the indicator by a second distance selected to be less than the first distance or a second angle selected to be less than the first angle on the path at least partially based on the first gesture input.
